(19) United States
(12) Patent Application Publication
(10) Pub. No.: US 2025/0153948 A1
(43) Pub. Date: May 15, 2025

(54) DEBRIS CHUTE ASSEMBLY

(71) Applicant: TDR Systems, Inc. t/a CHUTES International, Waldorf, MD (US)

(72) Inventor: Chad Helmer, Battle Ground, WA (US)

(73) Assignee: TDR Systems, Inc. t/a CHUTES International, Waldorf, MD (US)

(21) Appl. No.: 18/388,213

(22) Filed: Nov. 9, 2023

(51) Int. Cl. B65G 11/02

(52) U.S. Cl. CPC B65G 11/02

(57) ABSTRACT

A debris chute assembly for removing debris from a height during construction or similar activity includes a scaffold, a plurality of wall members, and a plurality of corner members. The wall members hang on ledgers of the scaffold in tubular sections which align with each other. The corner members attach to standards of the scaffold and retain the wall members in fixed positions with respect to the scaffold. Various embodiments of corner members are provided which attach to the scaffold by various fastening means.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to debris chutes and more particularly pertains to a new debris chute for removing debris from a height during construction or similar activity.

### (2) Description of Related Art Including Information Disclosed Under 37 CFR 1.97 and 1.98

The prior art discloses myriad debris chutes for use at construction sites or similar to remove debris from a height. It is known, for example, that plywood debris chutes are constructed to mount within scaffolds to form a debris chute. However, such debris chutes are labor intensive to construct, and plywood is not as durable as many types of sheet metal.

U.S. Patent Application No. 2020/0307915 describes a debris chute comprising wall members and corner members made of sheet metal that hook onto ledgers of a scaffold. Fasteners are not positively described in the specification of this application beyond the hooked portions of the wall members and corner members which hang on ledgers of the scaffold. Without further attachment or locking mechanism, the wall members of the disclosed debris chute are likely to swing due to wind or other forces. Such movement would facilitate damage to the wall members as debris is dropped onto the swinging wall members and facilitate the release of dust or other objects through gaps formed between wall members.

A new debris chute comprising wall members and corner members attached to a scaffold which ensures that the wall members remain fixedly secured to the scaffold is therefore desirable. A debris chute of the type described above which fixedly secures the corner members to the scaffold and causes the corner members to abut the wall members, thereby fixedly securing the wall members to the scaffold, would solve the problem presented. It is also noted that such a device would also be advantageous over a similar device which fastens adjacent corner and wall members via threaded fasteners or the like, because the creation and alignment of holes in the corner and wall members would be avoided. Instead, only simple clamping mechanisms or the like would be required to cause the corner members to engage the standards of the scaffold.

### BRIEF SUMMARY OF THE INVENTION

An embodiment of the disclosure meets the needs presented above by generally comprising a scaffold comprising a plurality of standards which are spaced from each other. Each standard extends between a top end and a bottom end. The plurality of standards define a channel between the standards. The scaffold also includes a plurality of ledgers. Each ledger is coupled to and extends between a pair of associated standards of the plurality of standards. The ledgers are arranged in a plurality of levels which are spaced from each other along the channel. The ledgers of each channel are arranged in a closed loop formed around the channel. A plurality of wall members is coupled to the scaffold. The wall members are arranged in a plurality of tubular sections surrounding the channel. Each tubular section is coupled to the ledgers of an associated level of the plurality of levels. A plurality of corner members is also removably coupled to the scaffold. Each corner member is mounted to an associated standard of the plurality of standards and is positioned between a pair of associated wall members of the plurality of wall members. Each corner member comprises a corner panel which engages the pair of associated wall members to retain the panels of the pair of associated wall members in a fixed position with respect to the scaffold.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a debris chute assembly according to an embodiment of the disclosure.

FIG. 2 is a perspective view of an embodiment of the disclosure.

FIG. 3 is a detail perspective view of a corner member of an embodiment of the disclosure.

FIG. 4 is an exploded perspective view of a corner member and a standard of an embodiment of the disclosure.

FIG. 5 is a front view of a corner member of an embodiment of the disclosure.

FIG. 6 is a rear view of a corner member of an embodiment of the disclosure.

FIG. 7 is an exploded perspective view of a corner member and a standard of an embodiment of the disclosure.

FIG. 8 is a front view of a corner member of an embodiment of the disclosure.

FIG. 9 is a rear view of a corner member of an embodiment of the disclosure.

FIG. 10 is an exploded perspective view of a corner member and a standard of an embodiment of the disclosure.

FIG. 11 is a front view of a corner member of an embodiment of the disclosure.

FIG. 12 is a rear view of a corner member of an embodiment of the disclosure.

FIG. 13 is an exploded detail perspective view of an embodiment of the disclosure.

FIG. 14 is an in-use view of an embodiment of the disclosure.

### DETAILED DESCRIPTION OF THE INVENTION

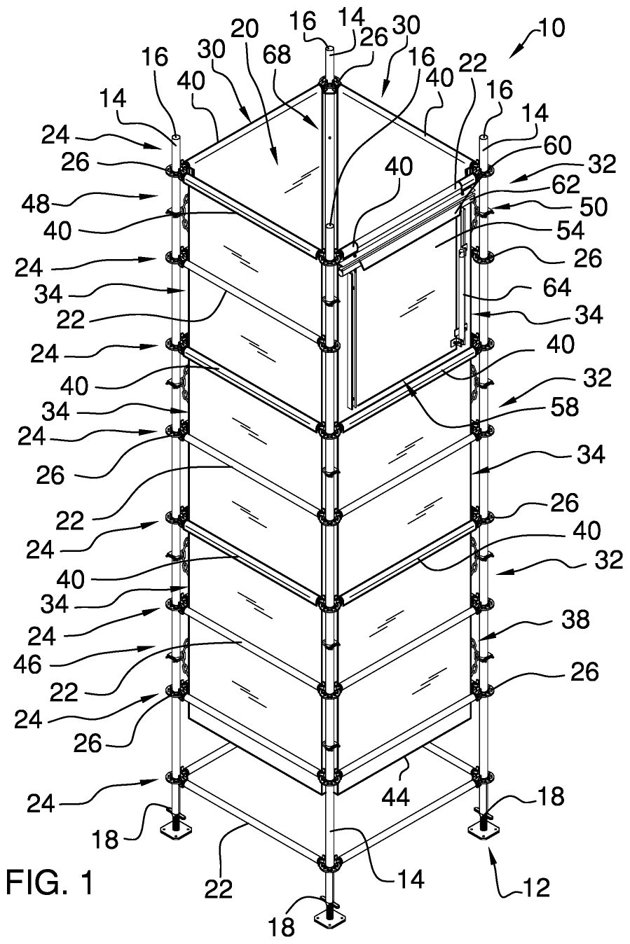

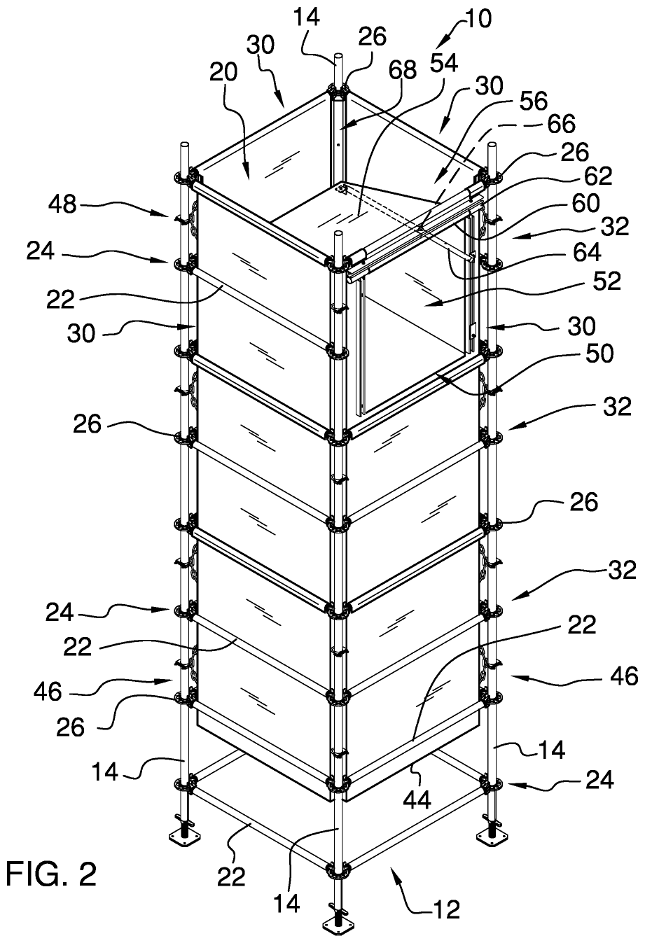

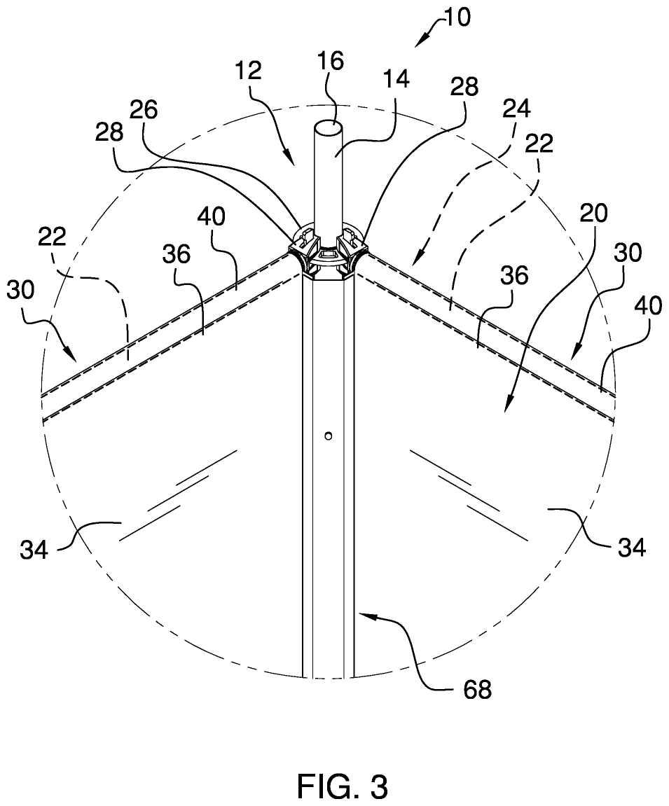

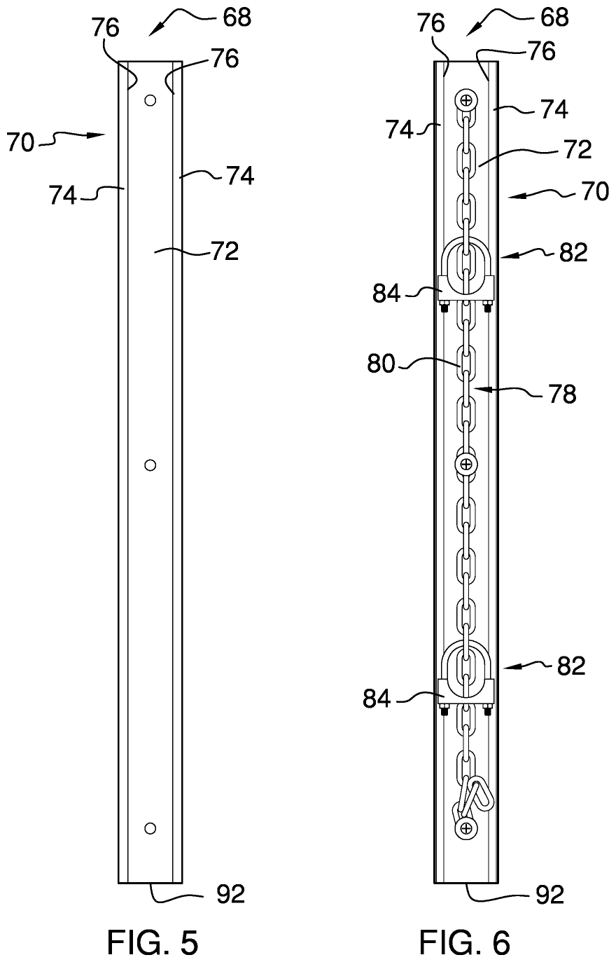

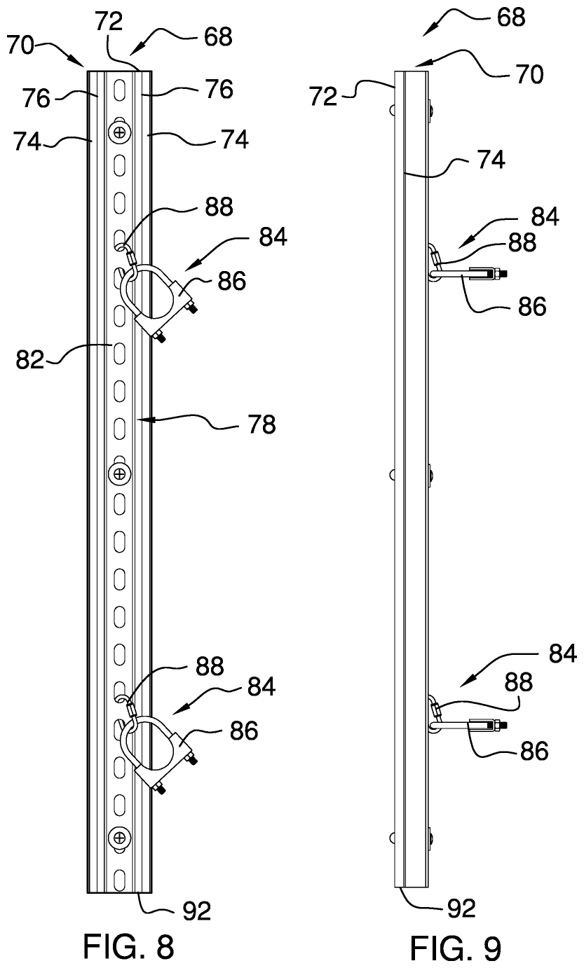

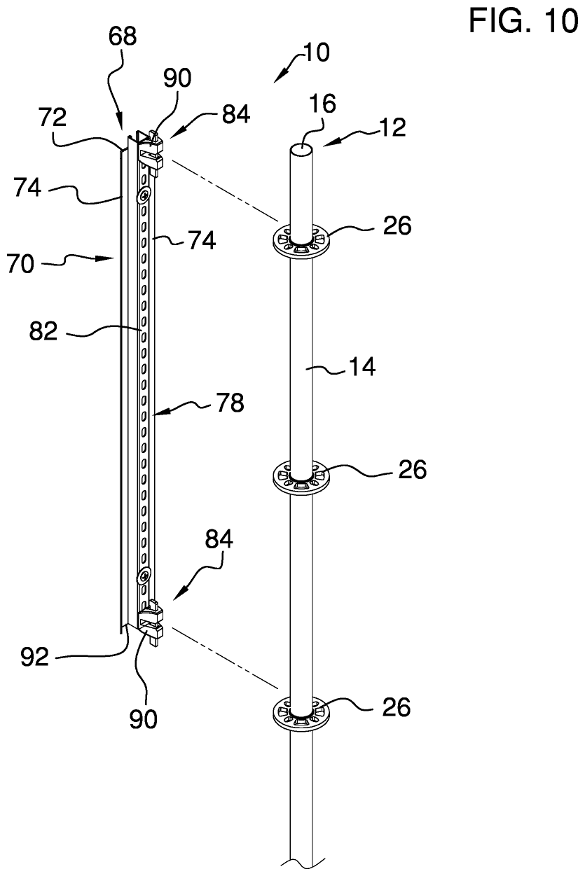

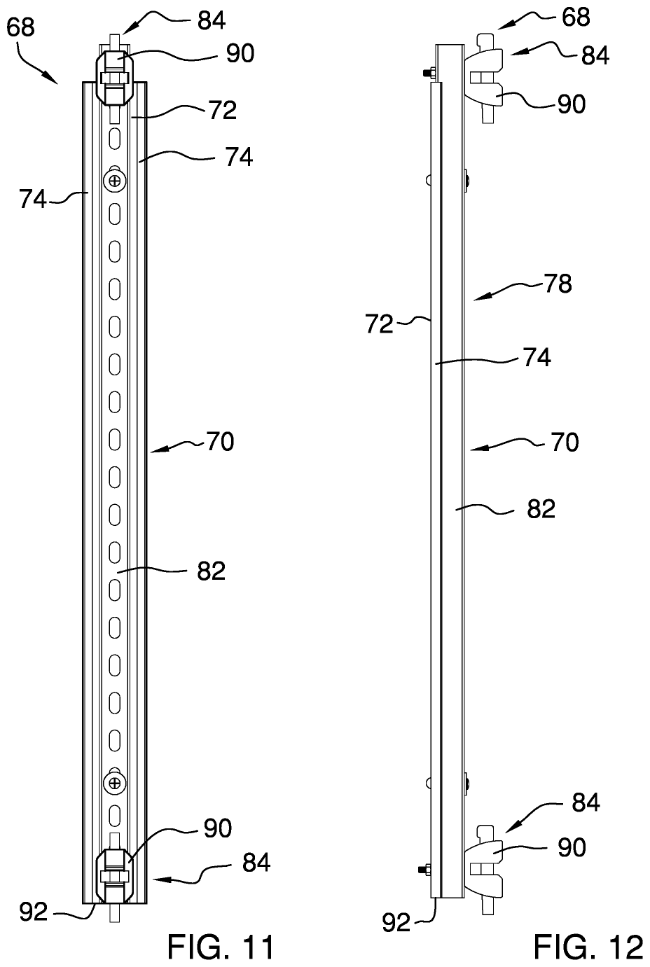

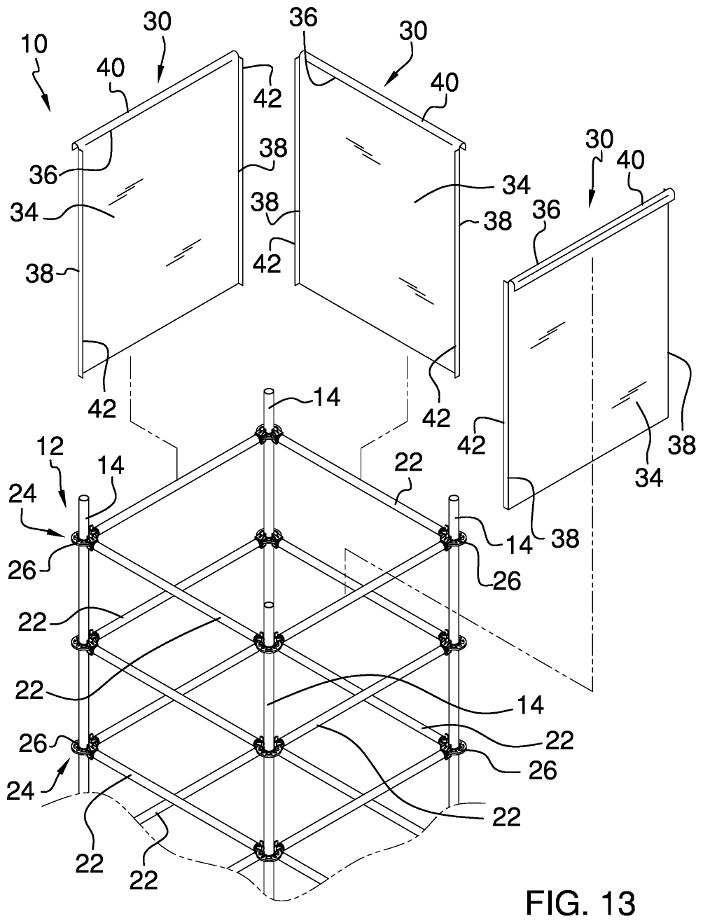

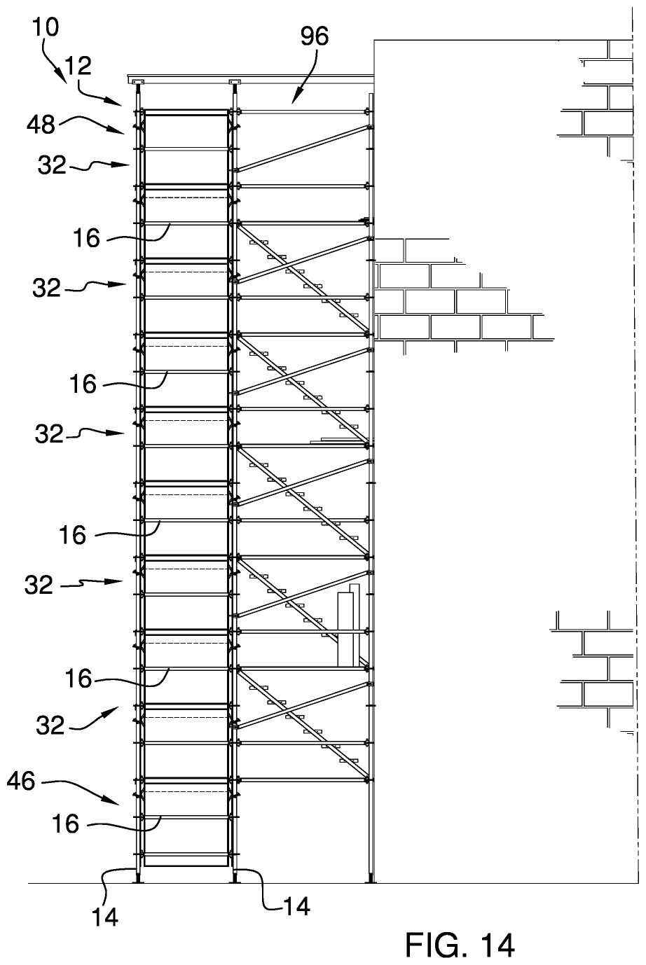

With reference now to the drawings, and in particular to FIGS. 1 through 14 thereof, a new debris chute embodying the principles and concepts of an embodiment of the disclosure and generally designated by the reference numeral 10 will be described.

As best illustrated in FIGS. 1 through 14, the debris chute assembly 10 generally comprises a scaffold 12 having a plurality of standards 14 and a plurality of ledgers 22. The standards 14 are spaced from each other and extend between a top end 16 and a bottom end 18. The standards 14 define a channel 20 between the standards 14. Each ledger 22 is coupled to and extends between a pair of associated standards 14 of the plurality of standards 14. The ledgers 22 are arranged in a plurality of levels 24 which are spaced from each other along the channel 20. In each level 24, the ledgers 22 form a closed loop around the channel 20.

The scaffold 12 also includes a plurality of rosettes 26 and a plurality of wedge pins 28. Each rosette 26 is coupled to an associated standard 14 of the plurality of standards 14, and each wedge pin 28 extends through an associated ledger 22 of the plurality of ledgers 22 and an associated rosette 26 of the plurality of rosettes 26, thereby securing the associated ledger 22 to the associated rosette 26. It is contemplated that other embodiments may not have the scaffold 12 but may instead use vertical and horizontal members similar to the standards 14 and ledgers 22 of the scaffold 12. It is noted, however, that a particular advantage of including the scaffold 12 is that the scaffold 12 may be easily attached to further scaffolding 96 built for workers to navigate to perform various construction and repair activities and to access the debris chute assembly 10. The scaffold 12 of some embodiments may not have rosettes 26 and wedge pins 28, instead relying on alternative attachment means known to the art such as clamps.

A plurality of wall members 30 is removably coupled to the scaffold 12. The wall members 30 are arranged in a plurality of tubular sections 32 which surround the channel 20. Each tubular section 32 is coupled to the ledgers 22 of an associated level 24 of the plurality of levels 24. Each wall member 30 of the plurality of wall members 30 comprises a wall panel 34, a hook 40, and a pair of wall flanges 42. The hook 40 is coupled to an upper end 36 of the wall panel 34 and hangs onto an associated ledger 22 of the ledgers 22 of the associated level 24. The hook 40 extends outwardly from the channel 20 and from the wall panel 34. The pair of wall flanges 42 is coupled to a pair of lateral edges 38 of the wall panel 34. The wall flanges 42 extend inwardly into the channel 20 from the wall panel 34, and each wall flange 42 of the pair of wall flanges 42 is oriented perpendicularly to the wall panel 34. The wall panel 34, hook 40, and wall flanges 42 are formed of a unitary sheet metal but may use other suitable materials. A lower end 44 of each tubular section 32 except a bottommost section 46 of the plurality of tubular sections 32 overlaps an upper end 36 of an associated adjacent tubular section 32 of the plurality of tubular sections 32, closing any gaps that would otherwise form between tubular sections 32.

One of the wall members 30 of a topmost section 48 of the plurality of tubular sections 32 defines a hopper wall member 50, and other embodiments may include more hopper wall members 50. The wall panel 34 of the hopper wall member 50 defines an aperture 52 which extends through the wall panel 34. The hopper wall member 50 further comprises a door 54 to access the channel 20 through the aperture 52, a bar 62, and a prop 64. The door 54 is pivotally coupled to the wall panel 34 of the hopper wall member 50 and is movable between an open position 56 and a closed position 58 with respect to the aperture 52. The door 54 has a hooked upper edge 60 which extends around the bar 62, which is coupled to the wall panel 34. The bar 62 is oriented horizontally so that the door 54 is pivotable around the bar 62 and gravity biases the door 54 toward the closed position 58.

The prop 64 is engageable with the door 54 to maintain the door 54 in the open position 56. The prop 64 is telescopically extendable and is mounted to the door 54 and the wall panel 34 of the hopper wall member 50. The prop 64 is lockable in an extended position to maintain the door 54 away from the wall panel 34 in the open position 56. A locking pin 66 or similar may be employed to lock the prop 64 in the extended position. It may be possible to secure the prop 64 in multiple positions such that the door 54 may be adjusted to various degrees of openness with respect to the aperture 52.

A plurality of corner members 68 is removably coupled to the scaffold 12. Each corner member 68 is releasably mounted to an associated standard 14 of the plurality of standards 14 and is positioned between a pair of associated wall members 30 of the plurality of wall members 30. The corner members 68 act to close gaps made between wall members 30 of the same tubular section 32 and keep the wall members 30 from swinging inwardly into the channel 20 due to wind or other external forces.

Each corner member 68 comprises a corner panel 70, an elongated member 78, and a plurality of couplers 84. The corner panel 70 engages the pair of associated wall members 30 to retain the panels of the pair of associated wall members 30 in a fixed position with respect to the scaffold 12. The corner panel 70 comprises a central portion 72 and a pair of flange portions 74. The pair of flange portions 74 is coupled to a pair of side edges 76 of the central portion 72, and each flange portion 74 engages the wall flange 42 of one of the pair of associated wall members 30. The flange portions 74 may form 45-degree angles with the central portion 72 to align with the wall flanges 42 of the associated wall members 30. The corner panel 70 comprises a unitary sheet metal but may use other suitable materials.

The elongated member 78 is coupled to the corner panel 70 and is oriented parallel to the associated standard 14. The plurality of couplers 84 is coupled to the elongated member 78 and the associated standard 14, thereby securing the corner member 68 to the standard 14. A downward end 92 of each corner member 68 except a bottommost corner member (not shown) overlaps an upward end of an associated adjacent corner member 68 of the plurality of corner members 68, covering any gaps that would otherwise be formed between adjacent corner members 68.

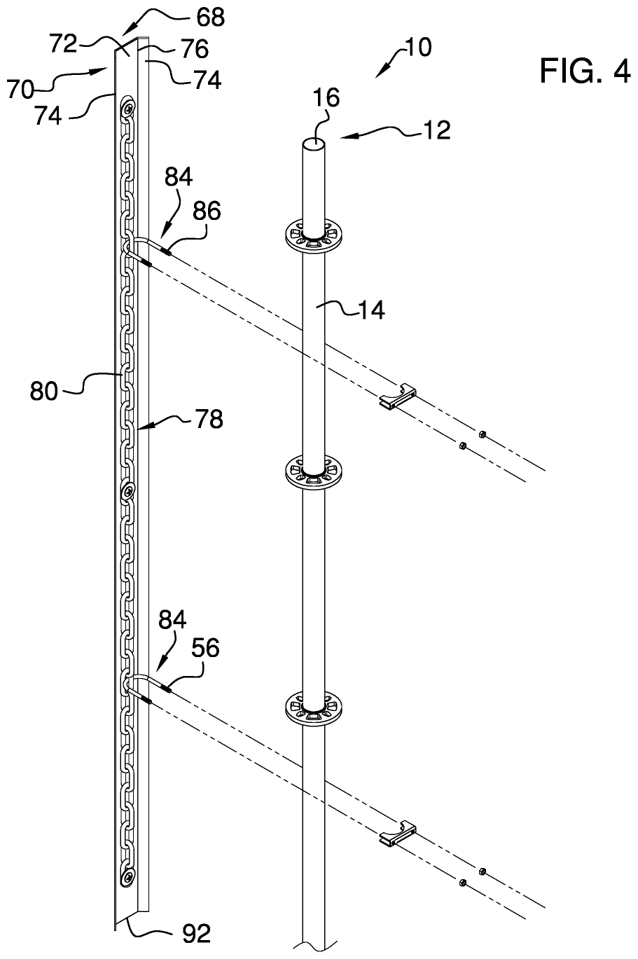

Various embodiments of the corner members 68 are depicted in the figures. In reference to FIGS. 4 through 6, a first embodiment of the corner members 68 is depicted, in which the elongated member 78 comprises a chain 80, and each coupler 84 of the plurality of couplers 84 comprises a U-bolt clamp 86. Each coupler 84 is interlocked with the chain 80 and clamps onto the associated standard 14. Couplers 84 of similar embodiments may include pipe clamps, ties, latches, or the like.

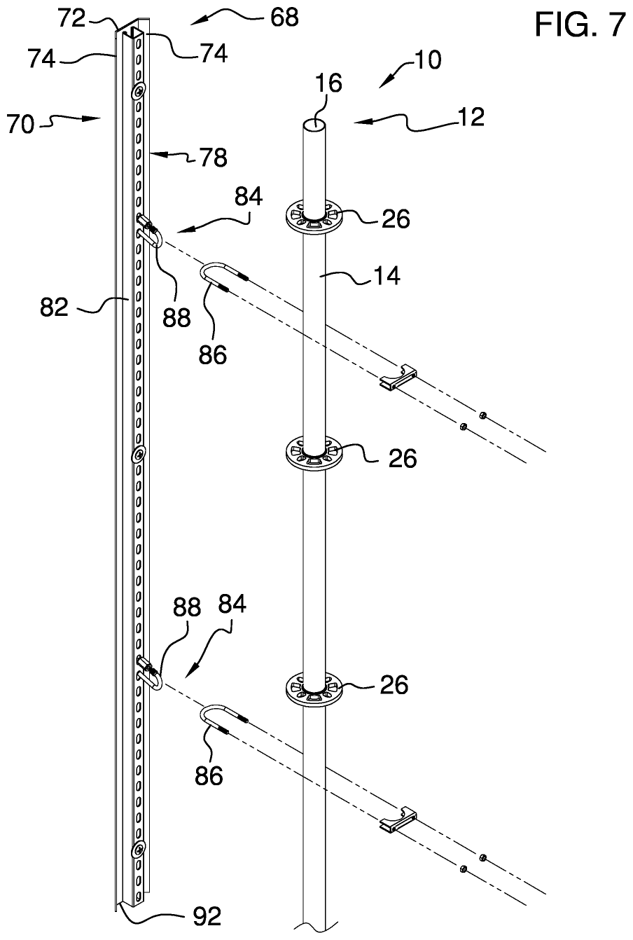

FIGS. 7 through 9 show a second embodiment of the corner members 68, in which the elongated member 78 comprises a slotted channel 82, and each coupler 84 comprises a quick-chain link 88 and a U-bolt clamp 86. The quick-chain link 88 of each coupler 84 is interlocked with the slotted channel 82. The U-bolt interlocks with the quick-chain link 88 and clamps onto the associated standard 14. Couplers 84 of similar embodiments may include pipe clamps, ties, latches, or the like.

In reference to FIGS. 9 through 12, a third embodiment of the corner members 68 is depicted in which the elongated member 78 comprises a slotted channel 82 and each coupler 84 of the plurality of couplers 84 comprises a wedge pin coupling 90. Each coupler 84 of the plurality of couplers 84 is coupled to an associated rosette 26 on the associated standard 14.

In use, the debris chute assembly 10 is assembled as described and debris from construction work or the like is fed through apertures 52 of hopper wall members 50 to be dropped into a desired location below the debris chute assembly 10. A dumpster or similar may be positioned below the debris chute assembly 10 to contain the dropped debris.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A debris chute assembly comprising:
a scaffold comprising:
a plurality of standards being spaced from each other, each standard of the plurality of standards extending between a top end and a bottom end, the plurality of standards defining a channel therebetween; and
a plurality of ledgers, each ledger of the plurality of ledgers being coupled to and extending between a pair of associated standards of the plurality of standards, the plurality of ledgers being arranged in a plurality of levels which are spaced from each other along the channel, the ledgers of each level of the plurality of levels being arranged to form a closed loop around the channel;
a plurality of wall members being removably coupled to the scaffold, the plurality of wall members being arranged in a plurality of tubular sections surrounding the channel, each tubular section of the plurality of tubular sections being coupled to the ledgers of an associated level of the plurality of levels, each wall member of the plurality of wall members comprising:
a wall panel; and
a hook being coupled to an upper end of the wall panel, the hook hanging onto an associated ledger of the ledgers of the associated level, the hook extending outwardly from the channel from the wall panel; and
a plurality of corner members being removably coupled to the scaffold, each corner member of the plurality of corner members being releasably mounted to an associated standard of the plurality of standards and being positioned between a pair of associated wall members of the plurality of wall members, each corner member of the plurality of corner members comprising a corner panel, the corner panel abutting the pair of associated wall members to retain the panels of the pair of associated wall members in a fixed position with respect to the scaffold.

2. The assembly of claim 1, wherein:
each wall member further comprises a pair of wall flanges being coupled to a pair of lateral edges of the wall panel, the pair of wall flanges extending inwardly into the channel from the wall panel, each wall flange of the pair of wall flanges being oriented perpendicularly to the wall panel; and
the corner panel of each corner member comprises a central portion and a pair of flange portions, the pair of flange portions being coupled to a pair of side edges of the central portion, each flange portion of the pair of flange portions engaging the wall flange of one of the pair of associated wall members.

3. The assembly of claim 1, wherein a lower end of each tubular section except a bottommost section of the plurality of tubular sections overlaps an upper end of an associated adjacent tubular section of the plurality of tubular sections.

4. The assembly of claim 1, wherein a downward end of each corner member of the plurality of corner members except a bottommost corner member overlaps an upward end of an associated adjacent corner member of the plurality of corner members.

5. The assembly of claim 1, wherein at least one of the wall members defines a hopper wall member, the wall panel of the hopper wall member defining an aperture extending through the wall panel, the hopper wall member further comprising a door pivotally coupled to the wall panel of the hopper wall member, the door being movable between an open position and a closed position with respect to the aperture.

6. The assembly of claim 5, wherein the door has a hooked upper edge, the hopper wall member further comprising a bar being coupled to the wall panel of the hopper wall member, the door being pivotable around the bar.

7. The assembly of claim 5, wherein the hopper wall member further comprises a prop engageable with the door to maintain the door in the open position, the prop being telescopically extendable, the prop being mounted to the door and the wall panel of the hopper wall member.

8. The assembly of claim 7, wherein the prop is lockable in an extended position to maintain the door away from the wall panel in the open position.

9. The assembly of claim 1, wherein each corner member further comprises:
an elongated member being coupled to the corner panel, the elongated member being oriented parallel to the associated standard; and
a plurality of couplers being coupled to the elongated member and the associated standard.

10. The assembly of claim 9, wherein, for each corner member of the plurality of corner members, the elongated member comprises a chain, each coupler of the plurality of couplers comprising a U-bolt clamp, each coupler being interlocked with the chain and clamping onto the associated standard.

11. The assembly of claim 9, wherein, for each corner member of the plurality of corner members, the elongated member comprises a slotted channel, each coupler of the plurality of couplers comprising a quick-chain link and a U-bolt clamp, the quick-chain link of each coupler being interlocked with the slotted channel, the U-bolt of each coupler being interlocked with the quick-chain link and clamping onto the associated standard.

12. The assembly of claim 9, wherein:
the scaffold further comprises a plurality of rosettes, each rosette of the plurality of rosettes being coupled to an associated standard of the plurality of standards; and
for each corner member of the plurality of corner members, the elongated member comprises a slotted channel, each coupler of the plurality of couplers comprising a wedge pin coupling, each coupler of the plurality of couplers being coupled to an associated rosette on the associated standard.

13. A debris chute assembly comprising:
a scaffold comprising:
a plurality of standards being spaced from each other, each standard of the plurality of standards extending between a top end and a bottom end, the plurality of standards defining a channel therebetween;
a plurality of ledgers, each ledger of the plurality of ledgers being coupled to and extending between a pair of associated standards of the plurality of standards, the plurality of ledgers being arranged in a plurality of levels which are spaced from each other along the channel, the ledgers of each level of the plurality of levels being arranged to form a closed loop around the channel;
a plurality of rosettes, each rosette of the plurality of rosettes being coupled to an associated standard of the plurality of standards; and
a plurality of wedge pins, each wedge pin extending through an associated ledger of the plurality of ledgers and an associated rosette of the plurality of rosettes, thereby securing the associated ledger to the associated rosette;
a plurality of wall members being removably coupled to the scaffold, the plurality of wall members being arranged in a plurality of tubular sections surrounding the channel, each tubular section of the plurality of tubular sections being coupled to the ledgers of an associated level of the plurality of levels, each wall member of the plurality of wall members comprising:
a wall panel;
a hook being coupled to an upper end of the wall panel, the hook hanging onto an associated ledger of the ledgers of the associated level, the hook extending outwardly from the channel from the wall panel; and
a pair of wall flanges being coupled to a pair of lateral edges of the wall panel, the pair of wall flanges extending inwardly into the channel from the wall panel, each wall flange of the pair of wall flanges being oriented perpendicularly to the wall panel;
wherein a lower end of each tubular section except a bottommost section of the plurality of tubular sections overlaps an upper end of an associated adjacent tubular section of the plurality of tubular sections;
wherein one of the wall members of a topmost section of the plurality of tubular sections defines a hopper wall member, the wall panel of the hopper wall member defining an aperture extending through the wall panel, the hopper wall member further comprising:
a door pivotally coupled to the wall panel of the hopper wall member, the door being movable between an open position and a closed position with respect to the aperture, the door having a hooked upper edge;
a bar being coupled to the wall panel of the hopper wall member, the door being pivotable around the bar; and
a prop engageable with the door to maintain the door in the open position, the prop being telescopically extendable, the prop being mounted to the door and the wall panel of the hopper wall member, the prop being lockable in an extended position to maintain the door away from the wall panel in the open position; and
a plurality of corner members being removably coupled to the scaffold, each corner member of the plurality of corner members being releasably mounted to an associated standard of the plurality of standards and being positioned between a pair of associated wall members of the plurality of wall members, each corner member of the plurality of corner members comprising:
a corner panel, the corner panel abutting the pair of associated wall members to retain the panels of the pair of associated wall members in a fixed position with respect to the scaffold, the corner panel comprising a central portion and a pair of flange portions, the pair of flange portions being coupled to a pair of side edges of the central portion, each flange portion of the pair of flange portions engaging the wall flange of one of the pair of associated wall members;
an elongated member being coupled to the corner panel, the elongated member being oriented parallel to the associated standard; and
a plurality of couplers being coupled to the elongated member and the associated standard;
wherein a downward end of each corner member of the plurality of corner members except a bottommost corner member overlaps an upward end of an associated adjacent corner member of the plurality of corner members.

14. The assembly of claim 13, wherein, for each corner member of the plurality of corner members, the elongated member comprises a chain, each coupler of the plurality of couplers comprising a U-bolt clamp, each coupler being interlocked with the chain and clamping onto the associated standard.

15. The assembly of claim 13, wherein, for each corner member of the plurality of corner members, the elongated member comprises a slotted channel, each coupler of the plurality of couplers comprising a quick-chain link and a U-bolt clamp, the quick-chain link of each coupler being interlocked with the slotted channel, the U-bolt of each coupler being interlocked with the quick-chain link and clamping onto the associated standard.

16. The assembly of claim 13, wherein, for each corner member of the plurality of corner members, the elongated member comprises a slotted channel, each coupler of the plurality of couplers comprising a wedge pin coupling, each coupler of the plurality of couplers being coupled to an associated rosette on the associated standard.
